(19) United States
(12) Patent Application Publication
(10) Pub. No.: US 2010/0279145 A1
(43) Pub. Date: Nov. 4, 2010

(54) Coating structure and method for forming the same

(75) Inventors: Yasushi Asano, Nagoya-city (JP); Keita Yanagawa, Anjo-city (JP); Hiroyoshi Sugawara, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/801,647

(22) Filed: Jun. 18, 2010

Related U.S. Application Data
(62) Division of application No. 11/798,240, filed on May 11, 2007.

(30) Foreign Application Priority Data
May 12, 2006 (JP) 2006-133845
Feb. 28, 2007 (JP) 2007-050745

(51) Int. Cl. B32B 15/08; B32B 27/06; B32B 5/16; B32B 5/00

(52) U.S. Cl. 428/626; 428/422; 428/327; 428/336; 428/147

(57) ABSTRACT

A coating structure for a metal member includes a surface-smoothing layer formed on the metal member for smoothing a surface of the metal member, and a fluorine-based film formed on the surface-smoothing layer. The fluorine-based film can be formed by applying a fluorine-containing solution on the surface-smoothing layer, and by drying the fluorine-containing solution. The coating structure can be suitably used for a fuel injection nozzle.

### CROSS REFERENCE TO RELATED APPLICATIONS

This application is a Division of application Ser. No. 11/798,240, filed May 11, 2007, which claims priority from and is based on Japanese Patent Applications No. 2006-133845 filed on May 12, 2006, and No. 2007-050745 filed on Feb. 28, 2007, the contents of each of which are incorporated herein by reference in its entirety.

### BACKGROUND OF THE INVENTION

1. Field of the Invention

The present invention relates to a coating structure including a fluorine-based film on a metal member, and a method for forming the same.

2. Description of the Related Art

Conventionally, in order to provide a water-shedding property to a member such as a metal member, a coating structure including a fluorine-based film is used, for example. The coating structure can be used for a member which is heated and is required to have an antifouling property, e.g., a vehicle component such as a fuel injection nozzle as disclosed in JP-A-8-144893, and a household product such as a flying pan and a cooking stove.

However, a thickness of the fluorine-based film is typically very thin, e.g., a few dozens nm. Therefore, when the fluorine-based film is directly formed on the metal member having a large surface roughness, the fluorine-based film becomes uneven with a sink, and cannot provide a sufficient water-shedding property. Thus, when the fluorine-based film is formed on the metal member having the large surface roughness, the metal member is required to be smoothed in advance so that the surface roughness is within a nanometer range, for preventing the sink in the fluorine-based film.

Therefore, it is required that a coating structure can be formed on the metal member having the large surface roughness without a process of smoothing the surface of the metal member, while having the sufficient water-shedding property which is not reduced by heating.

In the fuel injection nozzle with the fluorine-based film, the nozzle is subjected to a high temperature due to a high-fuel injection pressure, and a fuel situation is changed due to a utilization of a biofuel. Therefore, the fuel injection nozzle has a problem that a large amount of foreign material, which is considered as a product generated from fuel, adheres to a needle of the fuel injection nozzle.

The fuel injection nozzle includes a nozzle body having an injection hole for injecting fuel, and the needle which is housed in the nozzle body to be slidable. The fuel injection nozzle injects fuel by sliding the needle for opening the injection hole. When the large amount of foreign material adheres to the needle, the foreign material may pile-up into a mass, and the mass may drop off between the nozzle body and the needle. In this case, the needle may be difficult to slide, and furthermore, the needle may adhere to the nozzle body and an engine may fail to start.

Therefore, the fuel injection nozzle is required to have a coating structure, which has a sufficient water-shedding property and can prevent the adherence of the foreign material.

### SUMMARY OF THE INVENTION

In view of the foregoing problems, it is an object of the present invention to provide a coating structure having a sufficient water-shedding property which is not reduced by heating. The coating structure may be used for a metal member having a large surface roughness. And another object of the invention is to provide a method for forming a coating structure having a sufficient water-shedding property, on a metal member, regardless of surface roughness of the metal member.

According to an aspect of the invention, a coating structure for a metal member includes a surface-smoothing layer, formed on the metal member, for smoothing a surface of the metal member, and a fluorine-based film formed on the surface-smoothing layer.

The fluorine-based film is not formed directly on the metal member, but formed on the surface-smoothing layer which is formed on the metal member. Therefore, the coating structure can have the sufficient water-shedding property which is not reduced by heating. Further, the coating structure may be used for a metal member having the large surface roughness.

According to another aspect of the invention, a method for forming a coating structure for a metal member is provided. The method includes a step of forming a surface-smoothing layer on a metal member to smooth a surface of the metal member, a step of applying a fluorine-containing solution on the surface-smoothing layer, and a step of drying the fluorine-containing solution to form a fluorine-based film.

In the method, the fluorine-based film is not formed directly on the metal member, but formed on the surface-smoothing layer which is formed on the metal member. Therefore, the coating structure formed by the method can have the sufficient water-shedding property which is not reduced by heating, regardless of a surface roughness of the metal member.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is a cross-sectional view showing a coating structure on a metal member, according to a first embodiment of the invention;

FIGS. 2A-2E are schematic diagrams showing a forming process of a composite film according to the first embodiment;

FIG. 3 is a schematic diagram showing a forming process of a fluorine-based film according to the first embodiment;

FIG. 4 is a graph showing relationships between heating times and water contact angles of coating structures according to a second embodiment (E) of the invention, and first comparative examples (C1), and a second comparative example (C2);

FIG. 5 is a schematic diagram showing a structure of a fuel injection nozzle according to a third embodiment of the invention;

FIG. 6 is a schematic diagram showing forming areas of a DLC (diamond-like carbon) film and a fluorine-based film on a surface of the fuel injection nozzle according to the third embodiment;

FIG. 7 is a schematic diagram showing a forming process of the DLC film according to the third embodiment;

FIG. 8 is a cross-sectional view of a coating structure according to the third embodiment;

FIG. 9 is a schematic diagram showing forming areas of a DLC film and a fluorine-based film on a surface of the fuel injection nozzle according to a first modification of the third embodiment;

FIG. 10 is a schematic diagram showing forming areas of a DLC film and a fluorine-based film on a surface of the fuel injection nozzle according to a second modification of the third embodiment; and

FIG. 11 is a schematic diagram showing forming areas of a DLC film and a fluorine-based film on a surface of the fuel injection nozzle according to a third modification of the third embodiment.

### DETAILED DESCRIPTION OF THE PREFERRED EMBODIMENTS

### First Embodiment

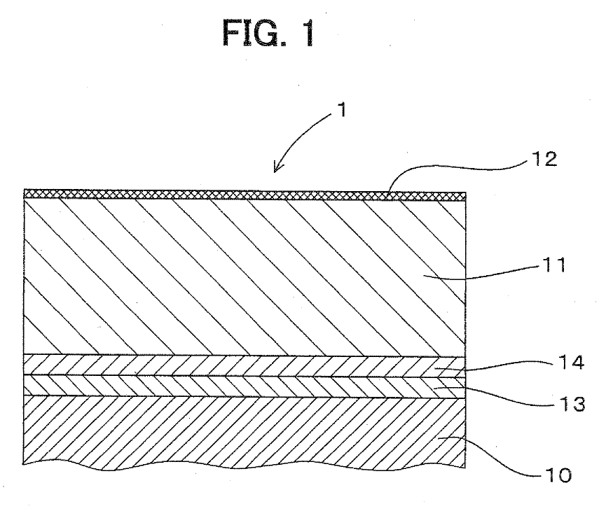

As shown in FIG. 1, a coating structure 1 according to a first embodiment of the invention includes a surface-smoothing layer 11 and a fluorine-based film 12. The surface-smoothing layer 11 for smoothing a surface of a metal member 10 is formed on the metal member 10, and the fluorine-based film 12 is formed on the surface-smoothing layer 11. As the surface-smoothing layer 11, a NiP/PTFE composite film (hereafter, composite film), in which PTFE (polytetrafluoroethylene) particles are dispersed in a NiP, is used. More details will be described below.

The coating structure 1 can be used for the metal member 10 made of a various metal-based material. An example material for the metal member 10 is a Fe-based material. When the coating structure 1 is formed on the Fe-based member 10, the coating structure 1 can provide a waterproof property (e.g., water-shedding property) effectively. In the first embodiment, an austenitic stainless steel (SUS304) consisting mainly of Fe is used. A surface roughness Rz(10) of the metal member 10 is about 2 μm, and the surface of the metal member 10 is uneven.

Between the metal member 10 and the composite film 11, two layers for increasing an adhesiveness of the composite film 11 are formed. One layer is a Ni strike film 13 formed directly on the metal member 10, as an adhesion layer. The other layer is a NiP film 14 formed directly on the Ni strike film 13, as a ground layer.

A preferred thickness of each of the Ni strike film 13 and the NiP film 14 is about in a range of 0.5 to 1.5 μm. When the thickness is under 0.5 μm, the adhesiveness of the composite film 11 may be not improved effectively. When the thickness is over 1.5 μm, a production cost of the coating structure 1 becomes high. In the first embodiment, the thickness of the Ni strike film 13 is 1 μm, and the thickness of the NiP film 14 is 1 μm, as an example.

The Ni strike film 13 may be formed by an electroplating, and the NiP film 14 may be formed by an electroless plating, for example. In each case, the Ni strike film 13 and the NiP film 14 are formed with high accuracies.

On the NiP film 14, the composite film 11 is formed. In the composite film 11, the PTFE particles are dispersed in the NiP as a base material. A preferred particle size of the PTFE particles is about in a range of 0.2 to 1 μm. When the particle size is under 0.2 μm, the composite film 11 may not provide the water-shedding property effectively. When the particle size is over 1 μm, it may be difficult to disperse the PTFE particles uniformly. A preferred content rate of the PTFE particles in the composite film is about in a range of 7 to 9 wt %. When the content rate of the PTFE particles in the composite film is under 7 wt %, the water-shedding property of the composite film 11 may be reduced. When the content rate of PTFE particles in the composite film is over 9 wt %, a heat-resistance of the composite film 11 may be reduced.

The composite film 11 may be formed by an electroless plating. In this case, the composite film 11 may be formed with a high accuracy. The composite film 11 may be formed by another method, such as an electroplating.

A preferred thickness of the composite film 11 is about in a range of 5 to 20 μm. When the thickness of the composite film 11 is under 5 μm, the composite film 11 may be difficult to be formed with the high accuracy on the metal member 10 having the large surface roughness. When the thickness of the composite film 11 is over 20 μm, it may be difficult to control the thickness. Therefore, more preferred thickness of the composite film 11 is about in a range of 5 to 15 μm.

In the first embodiment, a particle size of the PTFE particles is about in a range of 0.2 to 1 μm, the content rate of the PTFE particles in the composite film is about in a range of 7 to 9 wt % (i.e., 22 to 26 vol %), and a thickness of the composite film 11 is 10 μm, as an example.

A preferred surface roughness Rz of a surface, on which the composite film 11 is formed, i.e., a surface roughness Rz of a layer under the composite film 11, is not more than about 5 μm. When the surface roughness Rz is over 5 μm, a sick may be occurred in the composite film 11, and the composite film 11 may be not formed with the high accuracy. In the first embodiment, the surface roughness Rz of the surface, on which the composite film 11 is formed, i.e., a surface roughness Rz(14) of the NiP film 14 is 0.03 μm, as an example.

On the composite film 11, the fluorine-based film 12 is formed. The fluorine-based film 12 includes a fluoroalkylsilane. Therefore, the fluorine-based film 12 has a sufficient water-shedding property. A preferred thickness of the fluorine-based film 12 is about in a range of 0.01 to 0.5 μm. When the thickness of the fluorine-based film 12 is under 0.01 μm, a detachment and a deterioration of the fluorine-based film 12 may be occurred easily, and a durability of the fluorine-based film 12 may be reduced. When the thickness of the fluorine-based film 12 is over 0.5 μm, it may be difficult to control the thickness of the fluorine-based film 12. In the first embodiment, the thickness of the fluorine-based film 12 is 0.1 μm, as an example.

A preferred surface roughness Rz(11) of the composite film 11 is not more than about 0.1 μm. When the surface roughness Rz(11) is over 0.1 μm, the fluorine-based film 12 formed on the composite film 11 may have a sink, and may be not formed with a high accuracy. In the first embodiment, the surface roughness Rz(11) is 0.03 μm, as an example.

Next, a method for forming the coating structure 1 will be described. Before forming the various layers, a sample piece as the metal member 10 is preliminary cleaned with following four cleaning processes.

At first, the sample piece 10 is soaked in an alkaline cleaner (PAKUNA200TA made by Yuken Industry Co., Ltd.) at 60° C. for 10 min, and is rinsed by water. Then, the sample piece 10 is soaked in a hydrochloric acid aqueous solution at room temperature for 10 min, and is rinsed by water. Next, the sample piece 10 is soaked in an electrolytic cleaner (ASAHI CLEANER C-4000 made by C. Uyemura & Co., Ltd.), is electrolytic cleaned at 60° C. and at 2A/dm² of current density for 10 min, and is rinsed by water. Additionally, the sample piece 10 is soaked in the hydrochloric acid aqueous solution at room temperature for 5 min, and is rinsed by water.

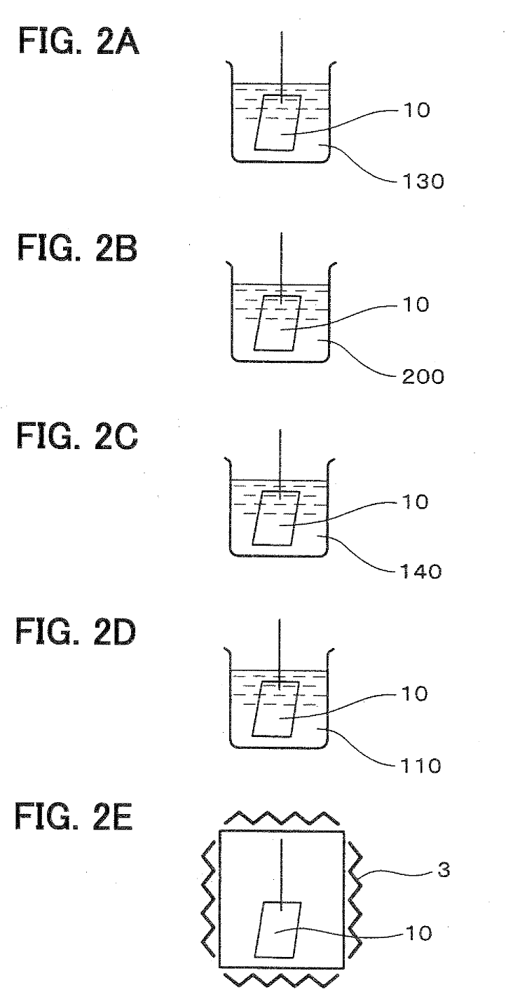

Next, as shown in FIG. 2A, the sample piece 10 is soaked in a Ni-containing solution 130, in which nickel chloride and acetic acid are mixed, at room temperature and at 2A/dm² of current density for 3 min, for forming the Ni strike film 13, and is rinsed by water. Then, as shown in FIG. 2B, the sample piece 10 is soaked in a sulfuric acid aqueous solution 200 at room temperature for 30 sec. for etching, and is rinsed by water. Next, as shown in FIG. 2C, the sample piece 10 is soaked in a NiP-containing solution 140 (TOP NICORON TOM-S made by Okuno Chemical Industries Co., Ltd.) at 95° C. for 5 min, for forming the NiP film 14. After that, without rinsing by water, the sample piece 10 is soaked in a NiP/PTFE-containing solution 110 (TOP NICOSIT FL-M, FL-1, or FL-A made by Okuno Chemical Industries Co., Ltd.) at 95° C. for 60 min. Then, the sample piece 10 is rinsed by water, and is dried in a heater 3 at 60° C., for forming the composite film 11.

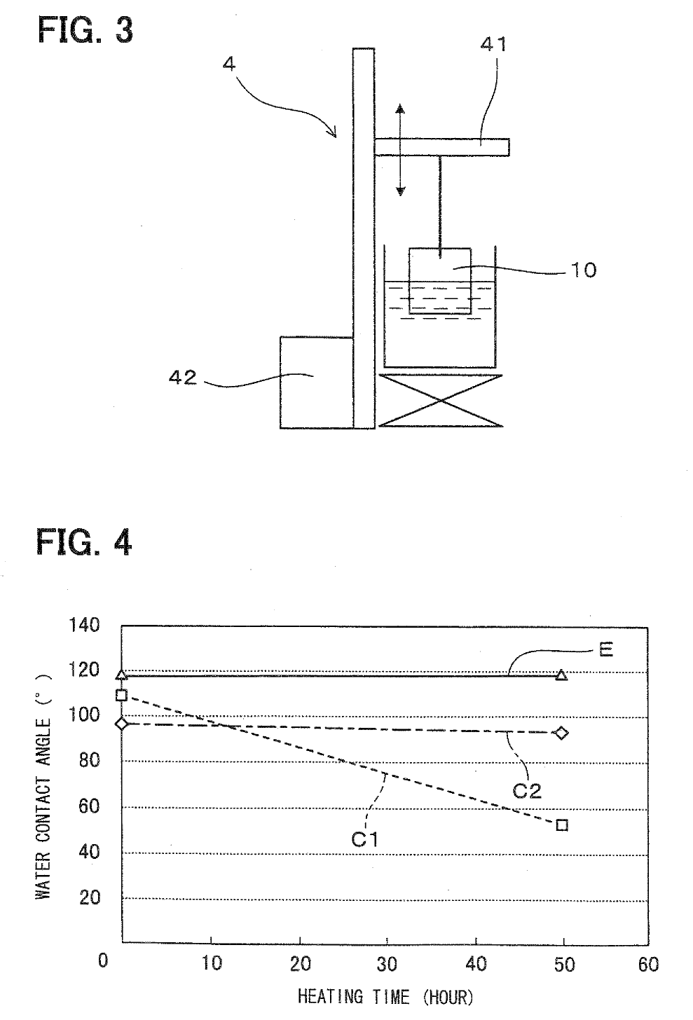

Next, the fluorine-based film 12 is formed on the composite film 11 of the sample piece 10, by using a coating apparatus 4. As shown in FIG. 3, the coating apparatus 4 includes a holding part 41 for holding the sample piece 10, and a motor 42 for moving up/down the holding part 41 at a predetermined rate.

The sample piece 10 is set to the holding part 41 of the filming apparatus 4. The holding part 41 is moved downward, and the sample piece 10 is soaked in a fluorine-containing solution 120 (e.g., fluoroalkylsilane: 1 to 20 wt %, alkylsilane: 1 to 10 wt %, a surfactant, and a deformer) such that a surface on which the fluorine-based film 12 should be formed is perpendicular to the liquid surface of the fluorine-containing solution 120. Then, the holding part 41 is moved upward, and the sample piece 10 is pulled-out from the fluorine-containing solution 120 at the predetermined rate, e.g., 30 mm/min. After that, the sample piece 10 is dried at 280° C. for 10 min for forming the fluorine-based film 12. In this way, the coating structure 1 in FIG. 1 is formed.

In the coating structure 1, the fluorine-based film 12 is not formed directly on the metal member 10, but formed on the composite film 11 as the surface-smoothing layer which is formed on the metal member 10. Therefore, the coating structure 1 can be used for the metal member 10 having the large surface roughness, and has the sufficient water-shedding property which is not reduced by heating.

In other words, in the coating structure 1, the composite film 11 including NiP as the base material is formed on the metal member 10. The composite film 11 can be formed to be thicker than the fluorine-based film 12, and a thickness accuracy (uniform thickness accuracy) of the composite film 11 is higher than that of the fluorine-based film 12. Therefore, even when the surface roughness of the metal member 10 is large in the first embodiment, by forming the thick composite film 11 on the metal member 10, the uneven surface of the metal member 10 is filled and smoothed with the composite film 11. Thus, the composite film 11 becomes a layer with a small surface roughness and the high thickness accuracy.

On the composite film 11, the fluorine-based film 12 is formed. The thickness of the fluorine-based film 12 can be made very thin, e.g., a few dozens nm. Therefore, the fluorine-based film 12 is easily affected by a surface roughness of the layer under the fluorine-based film 12. However, in the coating structure 1, the fluorine-based film 12 is formed on the composite film 11 with the small-surface roughness formed on the metal member 10. Therefore, even when the surface roughness of the metal member 10 is large in the first embodiment, the fluorine-based film 12 can be formed at a high accuracy without an effect due to the large surface roughness of the metal member 10. As a result, the fluorine-based film 12 becomes a uniform and high accuracy film without a sink.

As described above, in the coating structure 1 according to the first embodiment, the composite film 11, which can be formed to be thick, is formed on the metal member 10 as a first layer, and the thin fluorine-based film 12 is formed on the composite film 11 as a second layer. Therefore, the coating structure 1 can be used for the metal member 10 without being affect by the surface roughness of the metal member 10, even when the surface roughness of the metal member 10 is large. Thus, the metal member 10 is not required to be smoothed in advance until the surface roughness becomes an applicable surface roughness. Additionally, the coating structure 1 has the fluorine-based film 12 which is formed with the high accuracy on the metal member 10. Because the fluorine-based film 12 has the sufficient water-shedding property while having a uniform thickness, the coating structure 1 provides the sufficient water-shedding property and an antifouling property on the surface of the metal member 10.

The composite film 11 includes the NiP as the base material, and the NiP has a sufficient heat resistance. In the coating structure 1, the composite film 11 is formed between the metal member and the fluorine-based film 12. Therefore, even when the metal member 10 is heated, the water-shedding property of the fluorine-based film 12 is not reduced. Additionally, in the composite film 11, the water-shedding PTFE particles are dispersed in the NiP as the base material. Thus, the composite film 11 has the water-shedding property although the water-shedding effect is less than that of the fluorine-based film 12. Therefore, even when the fluorine-based film 12 is detached or deteriorated by heating or/and other reason, the composite film 11 prevents a substantial reduction of the water-shedding property of the coating structure 1.

The Ni strike film 13 is formed directly on the metal member 10. Therefore, the adhesiveness of the various films formed on the Ni strike film 13 can be improved. The composite film 11 is formed on the NiP film 14 that is applied on the Ni strike film 13. Therefore, the adhesiveness of the composite film 11 can be improved. Additionally, the composite film 11 is formed by the electroless plating. Therefore, the thickness accuracy of the composite film 11 can be improved.

The surface roughness of the surface, on which the composite film 11 is formed, i.e., the surface roughness Rz(14) of the NiP film 14 is as very small as about 0.03 μm. Therefore, the composite film 11 can be formed with the high accuracy. Additionally, the surface roughness Rz(11) of the composite film 11 is also as very small as about 0.03 μm. Therefore, the fluorine-based film 12 can be formed directly on the composite film 11 with the high accuracy. The fluorine-based film 12 includes the fluoroalkylsilane. Therefore, the fluorine-based film 12 has the sufficient water-shedding property.

In this way, the coating structure 1 according to the first embodiment can be used for the metal member 10 having the large surface roughness. The coating structure 1 has the sufficient water-shedding property which is not reduced by heating.

In the first embodiment, both the Ni strike film 13 and the NiP film 14 are formed between the metal member 10 and the composite film 11. However, according to a kind or a surface state of the metal member 10, the coating structure 1 may have both of the films 13 and 14, either of the films 13 or 14, or neither of the films 13 nor 14. For example, when a SCM420 is used as the metal member 10, both the Ni strike film 13 and the NiP film 14 are generally required. On the other hand, when a SPCC is used as the metal member 10, only the Ni strike film 13 is generally required. In each case, the coating structure 1 can be formed on the metal member 10 without being affected by the surface roughness of the metal member 10.

In the first embodiment, as a surface-smoothing layer for smoothing the surface of the metal member 10, the NiP/PTFE composite film 11 is used. However, a DLC (diamond-like carbon) can be used instead of the NiP/PTFE composite film 11. Because the DLC is a nonpolar material, the DLC film 11 may reduce an ion bonding with the foreign material. When the fluorine-based film 12 is formed on the DLC film 11, the surface of the fluorine-based film 12 becomes smooth, and an anchor effect based on the surface roughness is reduced. Therefore, the fluorine-based film 12 can prevent the adherence of the foreign material.

The DLC film 11 may be formed by a method selected from a plasma CVD, a sputtering, and an ion plating. In each case, the DLC film 11 can be formed with a high thickness accuracy.

A preferred thickness of the DLC film 11 is about in a range of 0.5 to 5 μm. When the thickness of the DLC film 11 is under 0.5 μm, the DLC film 11 may be not formed with the high accuracy on the metal member 10 having the large surface roughness, and a durability of the DLC film 11 may be reduced. When the thickness of the DLC film 11 is over 5 μm, it may be difficult to control the thickness of the DLC film 11.

A preferred surface roughness Rz of a surface, on which the DLC film 11 is formed, i.e., a surface roughness Rz of a layer under the DLC film 11, is not more than about 10 μm. When the surface roughness Rz is over 10 μm, the durability of the DLC film 11 may be reduced.

A preferred surface roughness Rz(11) of the DLC film 11 is not more than 10 μm. When the surface roughness Rz(11) is over 10 μm, the fluorine-based film 12 formed on the DLC film 11 may have a sink and may be not formed with the high accuracy.

The surface roughness Rz (11) of the DLC film 11 is smaller than the surface roughness Rz of the surface, on which the DLC film 11 is formed, because the surface is smoothed by forming the DLC film 11.

### Second Embodiment

In a coating structure E according to a second embodiment of the invention, the NiP/PTFE composite film 11 is formed directly on the metal member 10, and the fluorine-based film 12 is formed on the composite film 11.

The Ni strike film 13 and NiP film 14 described in the first embodiment are not formed in the second embodiment. In a coating structure C1 according to a first comparative example, only the fluorine-based film 12 is formed directly on the metal member 10. In a coating structure C2 according to a second comparative example, only the NiP/PTFE composite film 11 is formed directly on the metal member 10.

In each of the coating structures E, C1 and C2, the austenitic stainless steel (SUS304) is used as the material of the metal member 10 similarly to the first embodiment, and the surface roughness Rz(10) of the metal member 10 is 2 μm. Thicknesses and forming methods of the composite film 11 and the fluorine-based film 12 are similar to those of the first embodiment.

Next, water-shedding properties of the coating structures E, C1 and C2 are evaluated with a surface-free-energy measuring device (CA-VE type made by Kyowa Interface Science Co., Ltd) by measuring water contact angles in the conditions of φ 0.7 mm of a syringe diameter, 3 to 4μl of a measuring solution amount, φ/2 method, and a parallel contact angle.

FIG. 4 is a graph showing relationships between the water contact angles of the coating structures E, C1 and C2 and heating times at 250° C. until 50 hours. The water contact angle (i.e., water-shedding property) of the coating structure C1 is substantially reduced by heating. The water-shedding property of the coating structure C2 is not reduced as such by heating. However, an initial water-shedding property of the coating structure C2 is lower than that of the coating structure C1. In contrast, an initial water-shedding property of the coating structure E is higher than those of the coating structures C1 and C2, and the water-shedding property of the coating structure E is not reduced by heating.

The coating structure E according to the second embodiment includes both the fluorine-based film 12 having the sufficient water-shedding property, and the NiP/PTFE composite film 11 having the sufficient thermal resistance and the water-shedding property. Therefore, the coating structure E has the sufficient water-shedding property which is not reduced by heating.

### Third Embodiment

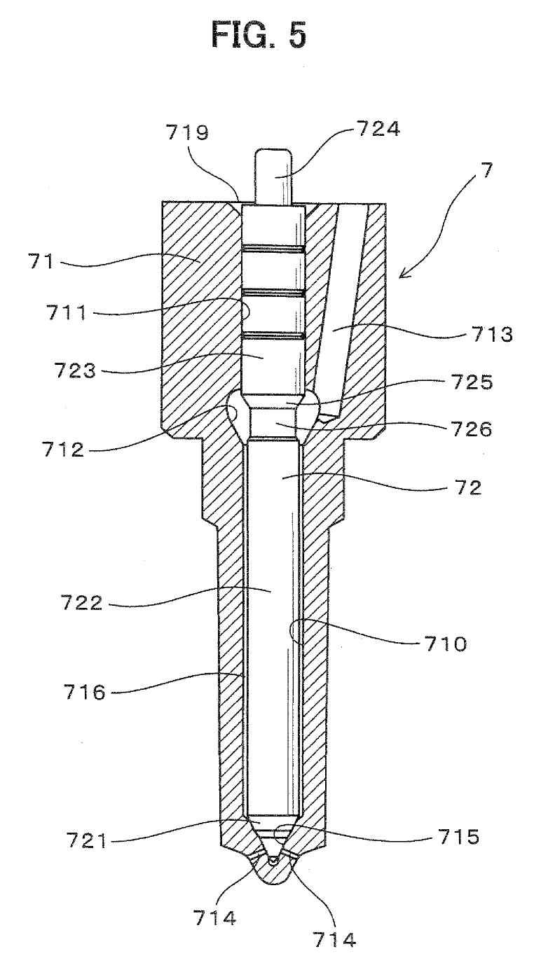

In a third embodiment, a coating structure 1 similar to that of the first embodiment is used for a fuel injection nozzle 7. As shown in FIG. 5, the fuel injection nozzle 7 can be used for a common-rail injection system of a diesel engine for injecting a high-pressure fuel into cylinders of the diesel engine. The injection nozzle 7 includes a nozzle body 71 and a needle 72. The injection nozzle 7 is set in a nozzle holder (not shown), and is attached to the diesel engine.

The nozzle body 71 includes a guide hole 710 in which the needle 72 is inserted, a sliding hole part 711 adjacent to an opening end part 719 of the guide hole 710, a fuel storing part 712 provided in the guide hole 710, a fuel introducing passage 713 connected to the fuel storing part 712, a cone-shaped valve seat 715 located at a leading end part of the guide hole 710, and a plurality of injection holes 714 provided to penetrate through the valve seat 715.

The guide hole 710 is provided in the nozzle body 71 to extend in an axial direction. The fuel storing part 712 is provided by expanding an inside diameter of the guide hole 710 for all circumstances, and has a circular space on an outer peripheral side of the needle 72 inserted in the guide hole 710. The fuel introducing passage 713 is provided in the nozzle body 71 for introducing the high-pressure fuel, which has been supplied to the nozzle holder, to the fuel storing part 712.

The needle 72 includes a sliding part 723 inserted in the sliding hole part 711 so that the sliding part 723 is slidable, a cone-shaped valve part 721 for opening and closing the injection holes 714 by seating on and separating from the valve seat 715, a shaft part 722 for connecting the sliding part 723 and the valve part 721, and a journal part 724 on an axial end side of the sliding part 723.

An outside diameter of the shaft part 722 is smaller than that of the sliding part 723. The shaft part 722 is inserted in the guide hole 710 for forming a fuel passage 716 with the guide hole 710. In a part of the shaft part 722 against the fuel storing part 712, a pressure-receiving surface 725 and a small diameter part 726 are formed. The pressure-receiving surface 725 is formed to be taper-shaped in which a diameter becomes small from the side of the sliding part 723 to the small diameter part 726. A diameter of the small diameter part 726 is the smallest in the shaft part 722. The pressure-receiving surface 725 and the small diameter part 726 form the fuel storing part 712 with the nozzle body 71.

The nozzle body 71 is operated as described bellow. The high-pressure fuel is pumped by a fuel pump (not shown) through the fuel introducing passage 713, and is stored in the fuel storing part 712. When a fuel pressure of the fuel storing part 712 which is applied to the pressure-receiving surface 725 becomes higher than a pressure in a direction that the needle 72 closes a valve, the needle 72 is lifted-up by a predetermined amount in the guide hole 710. Thus, the valve part 721 is separated from the valve seat 715, the fuel passage 716 and the injection holes 714 are connected, and the high-pressure fuel is injected from the plurality of injection holes 714 into the cylinders of the engine. After that, when the fuel pressure applied to the pressure-receiving surface 725 becomes lower than a pressure in the direction that the needle 72 closes the valve, the needle 72 falls in the guide hole 710, the valve part 721 seats on the valve seat 715, the communication between the fuel passage 716 and the injection holes 716 is cut off, and the fuel injection is stopped.

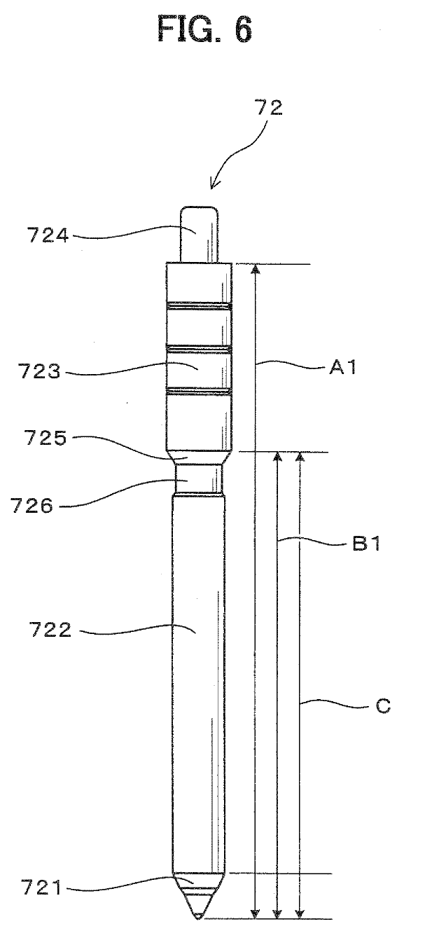

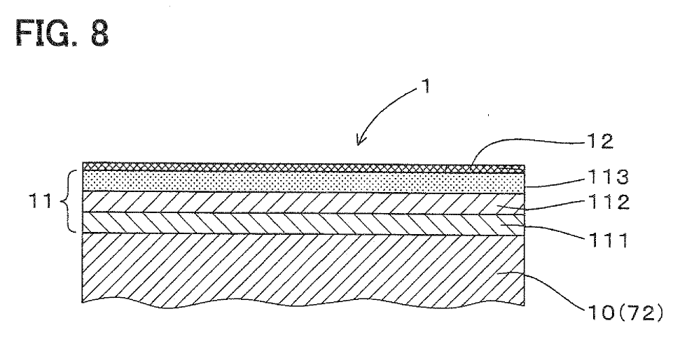

In the fuel injection nozzle 7, the coating structure 1 according to the third embodiment of the invention is formed on a part of the needle 72. As shown in FIG. 8, the coating structure 1 having the surface-smoothing layer 11 and the fluorine-based film 12 is formed on the needle 72 as the metal member 10. In the third embodiment, as shown in FIG. 6, the coating structure 1 is formed on the area C of the needle 72, i.e., the valve part 721 and the shaft part 722.

As the surface-smoothing layer 11, the DLC film 11 is used. In the third embodiment, the DLC film 11 is formed on the area A1 of the needle 72, i.e., including the valve part 721, the shaft part 722, and the sliding part 723. The fluorine-based film 12 is formed on the area B1 of the needle 72, i.e., including the valve part 721 and the shaft part 722.

Therefore, the coating structure 1 is formed in an overlapped part in which the area A1 and the area B1 are overlapped. Here, on the area A1, the DLC film 11 is formed, and on the area B1, the fluorine-based film 12 is formed. On the sliding part 723 of the needle 72, only the DLC film 11 is formed. An abrasion resistance of the sliding part 723 is improved by a high-hardness and a high-solid lubrication property of the DLC film 11.

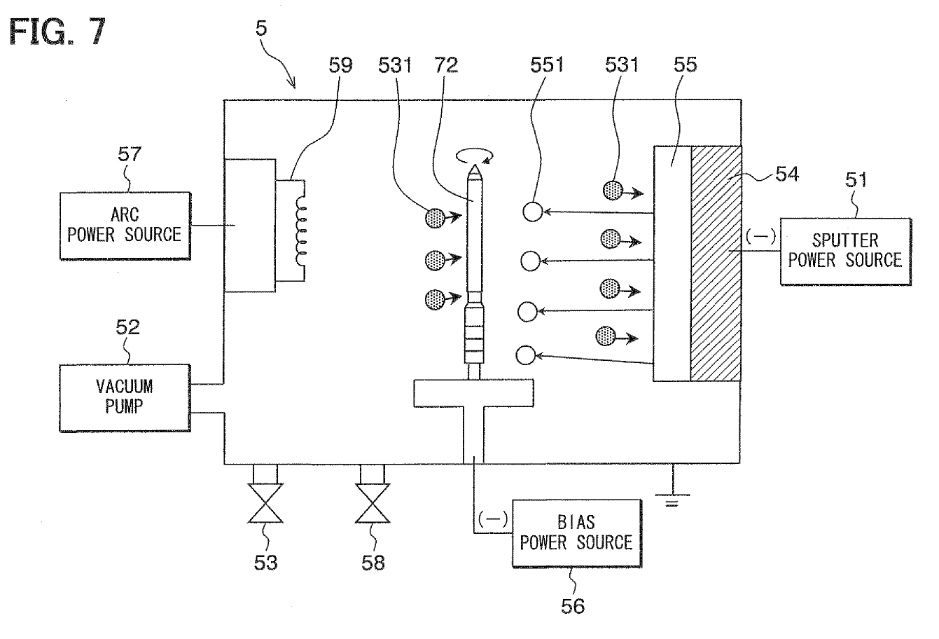

Next, a forming method of the DLC film 11 in the needle 72 will be described. In the third embodiment, the DLC film 11 is formed on a predetermined area of the needle 72 by a sputtering method. As shown in FIG. 7, a coating apparatus 5 for sputtering includes a sputter power source 51, a bias power source 56, an arc power source 57, a vacuum pump 52 for vacuating the coating apparatus 5, a first valve 53 for introducing argon gas 531 into the coating apparatus 5, a second valve 58 for introducing hydrocarbon gas into the coating apparatus 5, and a filament electron source 59. The sputter power source 51 is connected to a target electrode (−) 54. A target 55 which will be a filming material is set to the target electrode 54. The bias power source 56 is connected to the needle 72.

After vacuating the coating apparatus 5 by the vacuum pump 52, argon gas 531 is introduced. The arc power source 57 supplies electricity to the filament electron source 59, so that the argon gas 531 becomes cations. When the bias power source 56 supplies a negative potential to the needle 72, the argon cations 531 hit against the needle 72, and a surface of the needle 72 is activated. When the sputter power source 51 supplies a negative voltage to the target 55, the argon cations 531 hit against the target 55 for taking out atoms 551. The atoms 551 pile-up on the needle 72 for forming the film. In this process, the needle 72 is located to be constantly rotated.

When a middle layer is formed, Cr (chrome), WC (tungsten carbide), Ti (titan), and Si (silicon) are used as the target 55, for example. When the DLC film 11 is formed, hydrocarbon gas is also introduced, and C (carbon) is used as the target 55, for example.

In the third embodiment, the sputtering is performed on the predetermined area of the needle 72 with three different targets 55, i.e., Cr (chrome), W (tungsten), and C (carbon), in this order. Eventually, the DLC film 11 including a Cr layer 111, a W/C layer 112, and a C layer 113 is formed as shown in FIG. 8. In the W/C layer 112, W and C are mixed, and a ratio of W in the W/C layer 112 is decreased as toward the C layer 113 in the thickness direction.

In the fuel injection nozzle 7, the coating structure 1 is formed on a part of the needle 72 (in the third embodiment, the valve part 721 and the shaft part 722, for example), on which the foreign material such as a product generated from fuel may adhere. The coating structure 1 has the sufficient water-shedding property which is not reduced by heating. Therefore, the coating structure 1 can prevent the foreign material from adhering and piling-up on the surface of the needle 72. Thus, the coating structure 1 can keep a good sliding condition of the needle 72, and the fuel injection nozzle 7 can inject fuel for long time.

In the third embodiment, the DLC film 11 is not formed on the journal part 724 of the needle 72. The journal part 724 is required to perform a gliding process for a dimensional coordination of the needle 72 after forming the DLC film 11. When the DLC film 11 is formed, the gliding process becomes difficult. Therefore, the DLC film 11 is not formed on the journal part 724. When the dimensional coordination is not required and the gliding process is not performed, the DLC film 11 may be formed on the journal part 724.

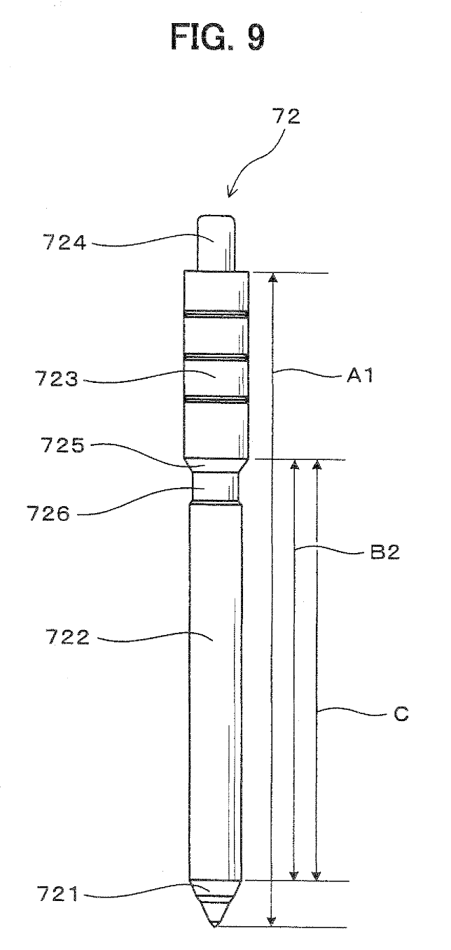

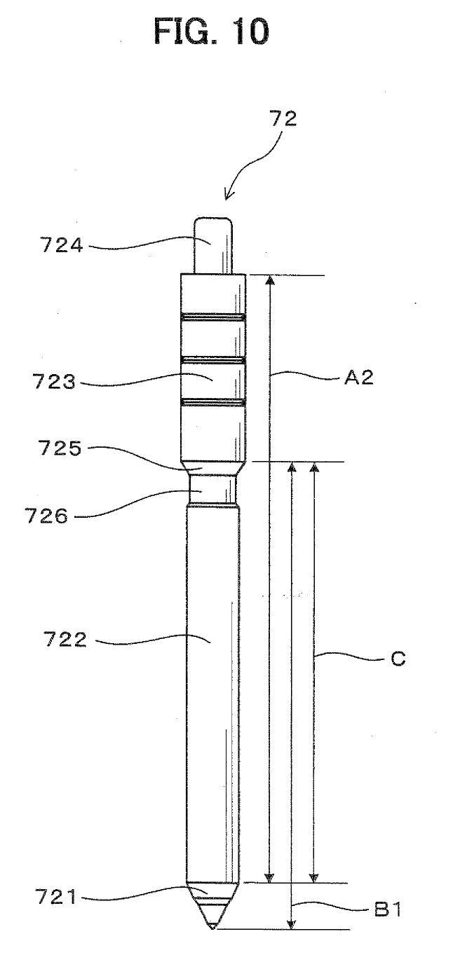

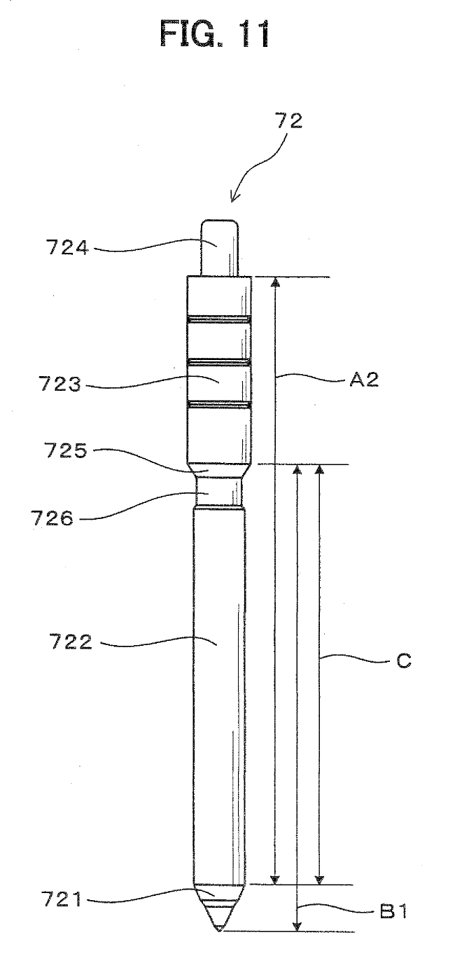

As shown in FIG. 9, the DLC film 11 may be formed on an area A1 of the needle 72, and the fluorine-based film 12 may be formed on an area B2 of the needle 72. Alternatively, as shown in FIG. 10, the DLC film 11 may be formed on an area A2 of the needle 72, and the fluorine-based film 12 may be formed on an area B1 of the needle 72. Furthermore, as shown in FIG. 11, the DLC film 11 may be formed on the area A2 of the needle 72, and the fluorine-based film 12 may be formed on the area B2 of the needle 72. In each case of FIGS. 9-11, the coating structure 1 is formed on the area C in which the area A1 or A2 and the area B1 or B2 overlap with each other.

As shown in FIGS. 6 and 9-11, the DLC film 11 may be formed on the area A1 or A2 in the needle 72 based on the situation. For example, in a new-development product, the DLC film 11 may be formed on the area A1 of the needle 72 because the DLC film 11 can be formed easily. However, in a conventional product which already has been used practically, the DLC film 11 is preferred to be formed on the area A2 of the needle 72, which excludes the valve part 721. In the conventional product, the valve part 721 may deteriorate with time because a friction is generated when the valve part 721 seats on and separates from the valve seat 715. Therefore, when the valve part 721 is checked, the valve part 721 may be optimized in accordance with a prediction of the deterioration. When the DLC film 11 is formed on the valve part 721, a pattern of the deterioration may be changed. Thus, when the valve part 721 is optimized similarly to the conventional case, a problem may be occurred. Therefore, in the conventional product, the DLC film 11 is formed on the area A2 in which the valve part 72 is excluded from the area A1.

In other words, in the third embodiment, the surface-smoothing layer 11 may be formed on the shaft part 722 and a part of the sliding part 723. Alternatively, the surface-smoothing layer 11 may be formed on the valve part 721, the shaft part 722, and a part of the sliding part 723. In each case, the surface of the needle 72 can be smoothed. Therefore, the fluorine-based film 12 formed on the surface-smoothing layer 11 becomes uniform without a sink, and can provide the sufficient water-shedding property which is not reduced by heating.

The fluorine-based film 12 may be formed on a part of the shaft part 722. Alternatively, the fluorine-based film 12 may be formed on the valve part 721 and a part of the shaft part 722. In each case, the fluorine-based film 12 can provide the sufficient water-shedding property on the predetermined portion of the needle 72.

The fluorine-based film 12 may be formed on an area which is not less than 80% of the shaft part 722. In this case, the fluorine-based film 12 can sufficiently prevent the needle 72 from adhering and piling-up of the foreign material such as the product generated from fuel.

Although the present invention has been fully described in connection with the preferred embodiments thereof with reference to the accompanying drawings, it is to be noted that various changes and modifications will become apparent to those skilled in the art.

What is claimed is:

1. A coating structure for a metal member comprising:
a surface-smoothing layer, formed on the metal member, for smoothing a surface of the metal member; and
a fluorine-based film formed on the surface-smoothing layer,
wherein the surface-smoothing layer includes a NiP/PTFE composite film in which PTFE particles are dispersed in NIP.

2. The coating structure according to claim 1, wherein:
the NiP/PTFE composite film is formed by an electroless plating.

3. The coating structure according to claim 1, wherein:
a content rate of the PTFE particles in the NiP/PTFE composite film is about 7 to 9 wt %.

4. The coating structure according to claim 1, wherein:
a particle size of the PTFE particles is about 0.2 to 1μm.

5. The coating structure according to claim 1, wherein:
a thickness of the NiP/PTFE composite film is about 5 to 20 μm.

6. The coating structure according to claim 1, wherein:
the surface-smoothing layer further includes a Ni strike film which is formed on the metal member, as an adhesion layer; and
the NiP/PTFE composite film is formed on the Ni strike film.

7. The coating structure according to claim 6, wherein:
a thickness of the Ni strike film is about 0.5 to 1.5 μm.

8. The coating structure according to claim 6, wherein:
the surface-smoothing layer further includes a NiP film which is formed on the Ni strike film, as a ground layer;
and the NiP/PTFE composite film is formed on the NiP film.

9. The coating structure according to claim 1, wherein:
the surface-smoothing layer further includes a NiP film formed on the metal member, as a ground layer; and
the NiP/PTFE composite film is formed on the NiP film.

10. The coating structure according to claim 9, wherein:
a thickness of the NiP film is about 0.5 to 1.5 μm.

11. The coating structure according to claim 1, wherein:
a surface roughness of a surface, on which the NiP/PTFE composite film is formed, is not more than about 5 μm.

12. The coating structure according to claim 1, wherein:
a surface roughness of the NiP/PTFE composite film is not more than about 0.1 μm.
